(19) United States
(12) Patent Application Publication
(10) Pub. No.: US 2014/0136035 A1
(43) Pub. Date: May 15, 2014

(54) SYSTEM AND METHOD OF CONTROLLING A DIRECT ELECTRICAL CONNECTION AND COUPLING IN A VEHICLE DRIVE SYSTEM

(71) Applicant: Fisker Automotive, Inc., Anaheim, CA (US)

(72) Inventors: Paul BOSKOVITCH, Costa Mesa, CA (US); J. Axel RADERMACHER, Foothill Ranch, CA (US); Uday DESHPANDE, San Diego, CA (US); Michael GROENE, Rochester, MI (US)

(21) Appl. No.: 13/901,859

(22) Filed: May 24, 2013

Related U.S. Application Data
(63) Continuation of application No. 13/521,443, now abandoned.
(60) Provisional application No. 61/294,722, filed on Jan. 13, 2010.

(51) Int. Cl. B60W 20/00

(52) U.S. Cl. CPC B60W 20/00; Y10S 903/903
USPC 701/22; 180/65.285; 903/903

(57) ABSTRACT

A method of controlling transition of operating modes in a hybrid vehicle includes the steps of providing a vehicle system having a generator coupled to an inverter and a motor coupled to an inverter. A switch box is disposed therebetween. The switch box includes a plurality of electrical switches that open and close to allow for direct electrical connection between the generator and the motor. The method detects a transfer condition using the vehicle system controller to transition from a first operating mode to a second operating mode. The transfer condition defines a predetermined efficiency threshold of the second operating mode being more efficient than the first operating mode. The method further preconditions the vehicle system by synchronizing electrical features between the generator and the motor. The method then actuates the switch box to close the plurality of switches allowing the generator and motor to electrically couple.

### CROSS-REFERENCE TO RELATED APPLICATION

This application claims the benefit of U.S. Provisional Patent Application No. 61/294,722 filed Jan. 13, 2010, the disclosure of which is incorporated herein by reference in its entirety.

### BACKGROUND

The present disclosure relates generally to a hybrid vehicle, and more particularly to a series hybrid electric vehicle power train.

### DESCRIPTION OF THE RELATED ART

Vehicles, such as a motor vehicle, utilize an energy source in order to provide power to operate a vehicle. While petroleum based products dominate as an energy source, alternative energy sources are available, such as methanol, ethanol, natural gas, hydrogen, electricity, solar or the like. A hybrid powered vehicle utilizes a combination of energy sources in order to power the vehicle. Such vehicles are desirable since they take advantage of the benefits of multiple fuel sources, in order to enhance performance and range characteristics of the hybrid vehicle relative to a comparable gasoline powered vehicle.

A series hybrid vehicle will utilize power provided by an engine mounted generator to power the motor driving the wheels. With such an arrangement, energy is transmitted from the engine to the wheels through various predefined conversion points. While this system works, each energy conversion point is less that 100% efficient, therefore there are energy losses throughout the process. As a result, fuel consumption increases and larger more expensive components may be required to satisfy power demands. Additionally, the engine, generator, and generator inverter all must be sized to handle peak engine power.

Thus there is a need in the art for a system and method of reducing energy losses through direct electrical connections between components and minimizing component size. There is a further need in the art for a drive system that reduces energy losses through direct electrical connections between a generator and motor and a method for electrically coupling these devices.

### SUMMARY

Accordingly, the present disclosure relates to a method of controlling transition of operational modes in a hybrid vehicle including the steps of: (a) providing a vehicle operating system having a generator coupled to an inverter and a motor coupled to an inverter, and a switch box disposed between the generator and the motor, the switch box having a plurality of electrical switches that open and close to allow for direct electrical connection between the generator and the motor; (b) detecting a transfer condition using the vehicle system controller to transition from a first operating mode to a second operating mode, wherein the transfer condition defines a predetermined efficiency threshold of the second operating mode being more efficient than the first operating mode; (c) preconditioning the vehicle system including the steps of: (i) synchronizing electrical frequency output from the generator and motor to be either equal or within a range such that they overlap; (ii) synchronizing electrical phases of generator and motor to be aligned; (iii) synchronizing power output from the generator and power output from the motor to be aligned; and (d) actuating the switch box to close the plurality of switches allowing the generator and motor to electrically couple and allow power output to transfer between the generator and the motor.

An advantage of the present disclosure is that a hybrid vehicle is provided that controls transition between a series operating mode and a direct connection operating mode. Another advantage of the present disclosure is that the operating efficiency of the vehicle system is improved, resulting in decreased fuel consumption. A further advantage of the present disclosure is that the size of the engine and generator can be reduced due to the improved operating efficiency. Still another advantage is that series drive efficiency is improved by reducing the AC-DC energy conversion losses when the engine is operational. A further advantage of the present disclosure is that it allows for downsizing of the inverters associated with both the generator and motor. Still a further advantage of the present disclosure is that the low temperature thermal system may be downsized. Yet a further advantage of the present disclosure is that peak power at a high speed drive mode is improved. Another advantage of the present disclosure is the potential to downsize the engine through a 10-20% reduction in power requirements. Other potential advantages is that the invention can be used for PHEV or HEV applications, can be scalable between a PHEV and an HEV, a reduced power electronics duty cycle improves reliability, increased number of limp home modes are available and the architecture is applicable to front, rear or all wheel drive applications.

Other features and advantages of the present disclosure will be readily appreciated, as the same becomes better understood after reading the subsequent description taken in conjunction with the accompanying drawings.

### BRIEF DESCRIPTION OF THE DRAWINGS

FIG. 1 is an example of powertrain architecture for a hybrid electric vehicle.

FIG. 2A-2B is a schematic block diagram illustrating a system of directly connecting electrical machines for the vehicle of FIG. 1 and associated operating states.

FIG. 3 illustrate schematic power flow distributions for an operating state 1 of a switch box of FIG. 2.

FIG. 4 illustrate schematic power flow distributions for an operating state 2 of the switch box of FIG. 2.

FIG. 5 illustrate schematic power flow distributions for an operating state 3 of the switch box of FIG. 2.

FIG. 6 is a schematic block diagram having a clutch.

FIG. 7 is a schematic block diagram having a third motor/generator coupled to front wheels and a switch box.

FIG. 8 is schematic block diagram having a third motor/generator coupled to front wheels and a second inverter.

FIG. 9 is schematic block diagram having a third motor/generator coupled to front wheels and a first inverter.

FIG. 10 is schematic block diagram having a third motor/generator coupled to front wheels and a first inverter and a second switch box disposed between the inverter and the third motor/generator.

FIG. 11 is schematic block diagram having a third motor/generator coupled to front wheels with a second switch box disposed between a first inverter and the third motor/generator and a first motor/generator.

FIG. 12. is another schematic block diagram having a third motor/generator coupled to front wheels with a second switch box disposed between a first inverter and the third motor/generator and a first motor/generator showing regenerative flow.

FIG. 13 is illustrates a second example block diagram of a switch box

FIG. 14 is another illustration of the switch box of FIG. 13.

FIG. 15 is a further illustration of the switch box of FIG. 13.

FIG. 16 is a schematic vehicle system illustrating electrical controls.

FIG. 17 is a flow chart associated with an example control method for transferring between operating modes.

### DESCRIPTION

The present disclosure provides for a system and method of direct electrical connection (e-Direct) for a multi-motor hybrid drive system is illustrated. The e-direct system may also be combined with a split gear transmission (e-Split). An example of such systems is also described in International Application No. PCT/US2010/040087 filed Jun. 25, 2010, the subject matter of which is incorporated herein by reference in its entirety for all purposes.

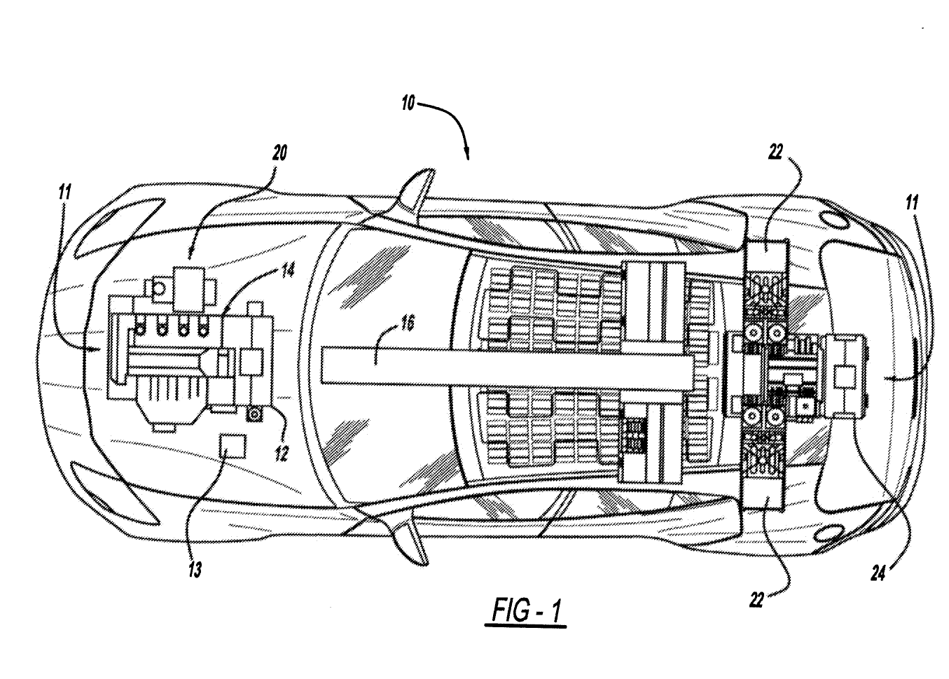

Referring to FIG. 1, a hybrid vehicle 10 is illustrated. In this example the vehicle 10 can be a plug-in hybrid vehicle powered by an internal combustion engine 20 and a battery 16 operable to be charged off-board. Both the engine 20 and the battery 16 can function as a power source for the vehicle 10. The vehicle 10 can be powered by each power source independently or in cooperation. A hybrid vehicle that uses a series configuration, such as an engine driving a generator and the generator providing electrical power to a drive motor, can utilize this architecture. The vehicle 10 could be a passenger vehicle, truck, off-road equipment, etc.

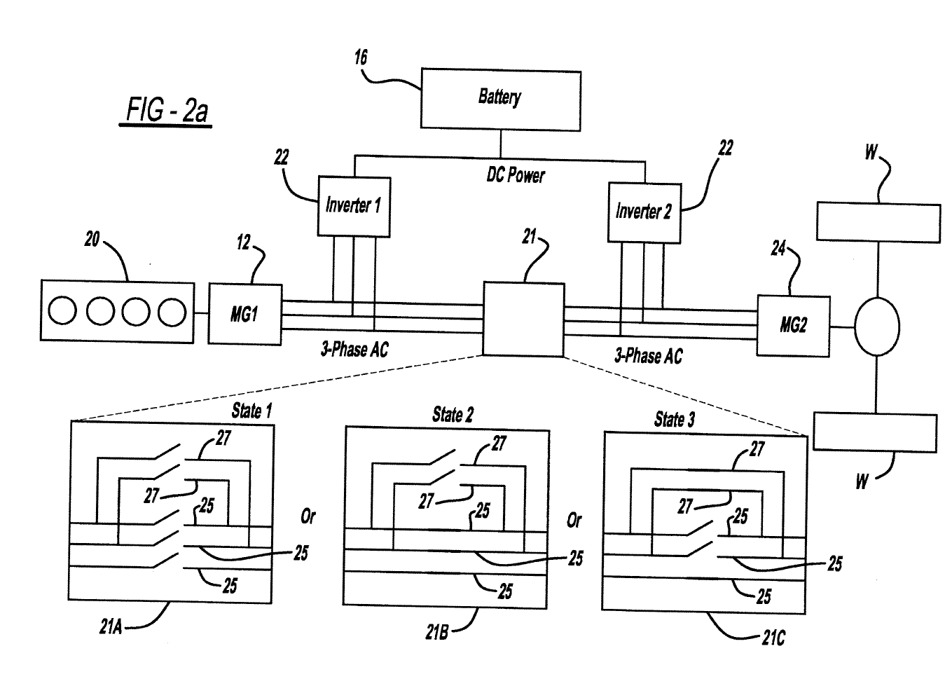

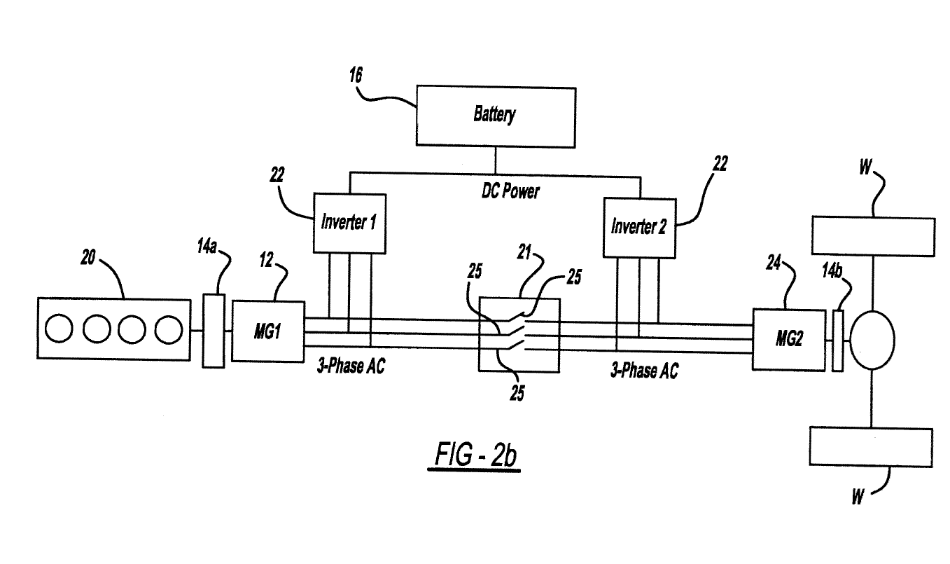

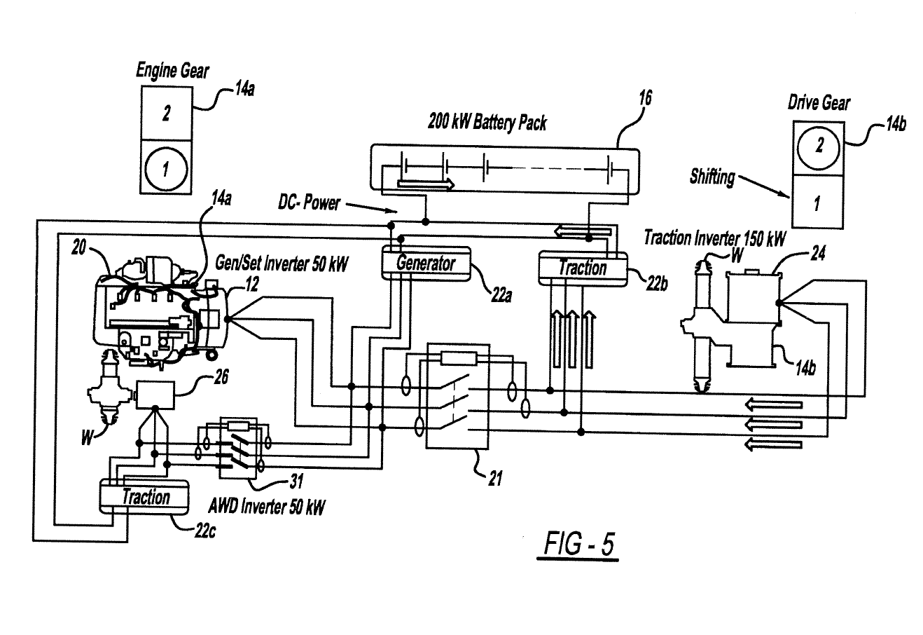

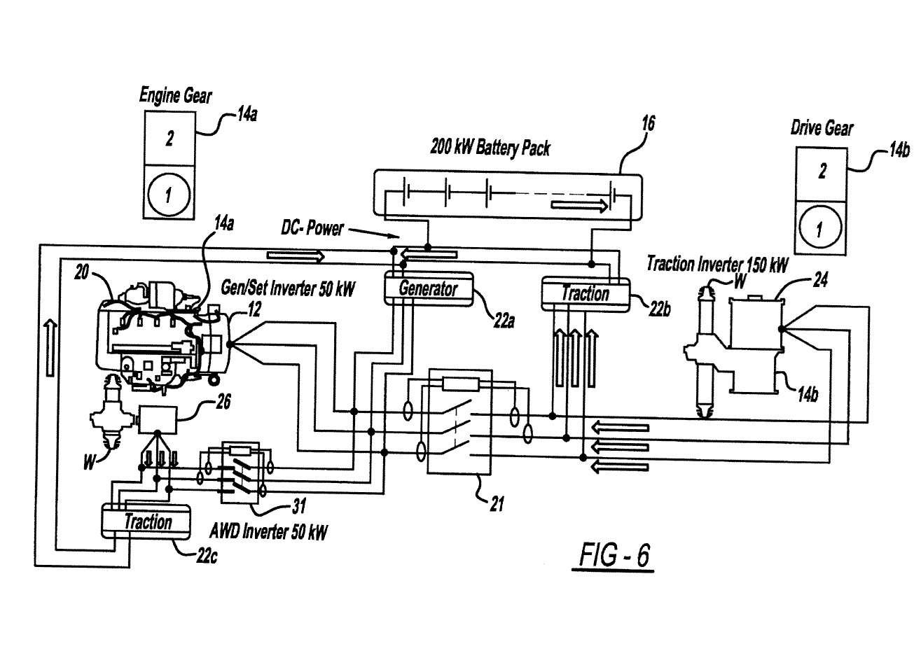

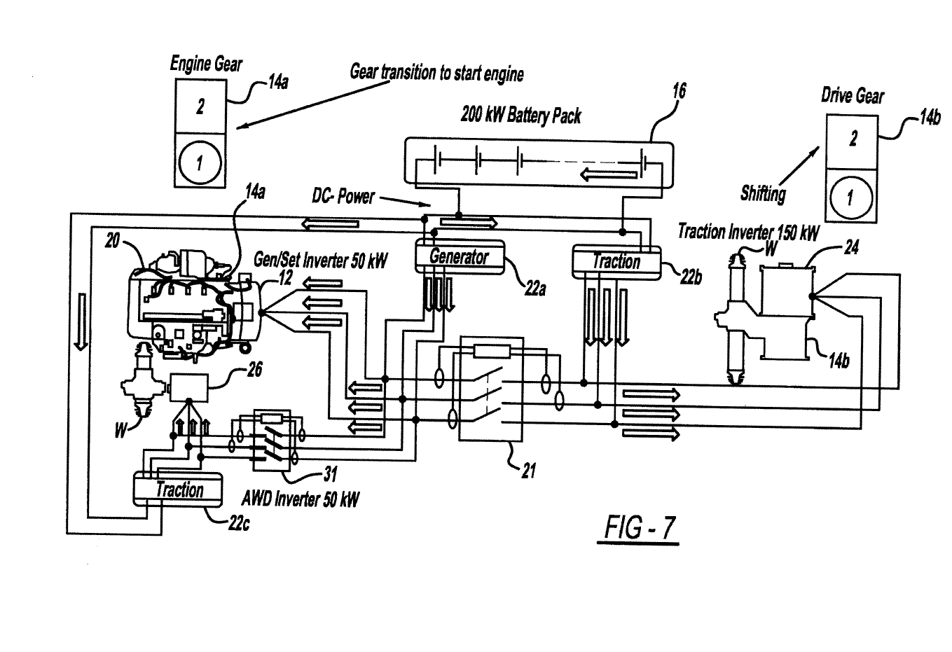

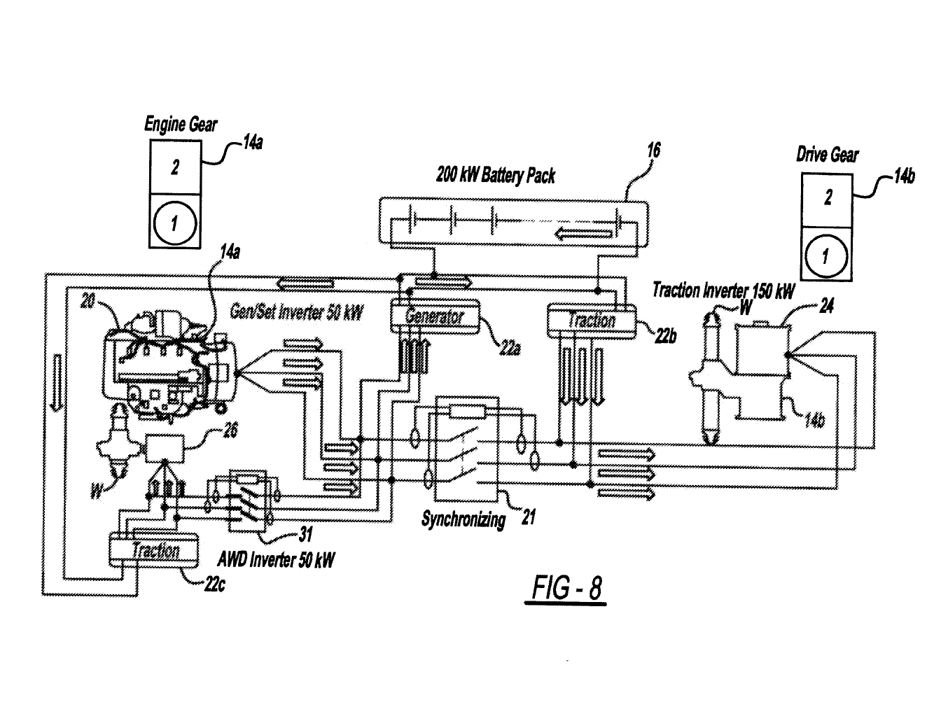

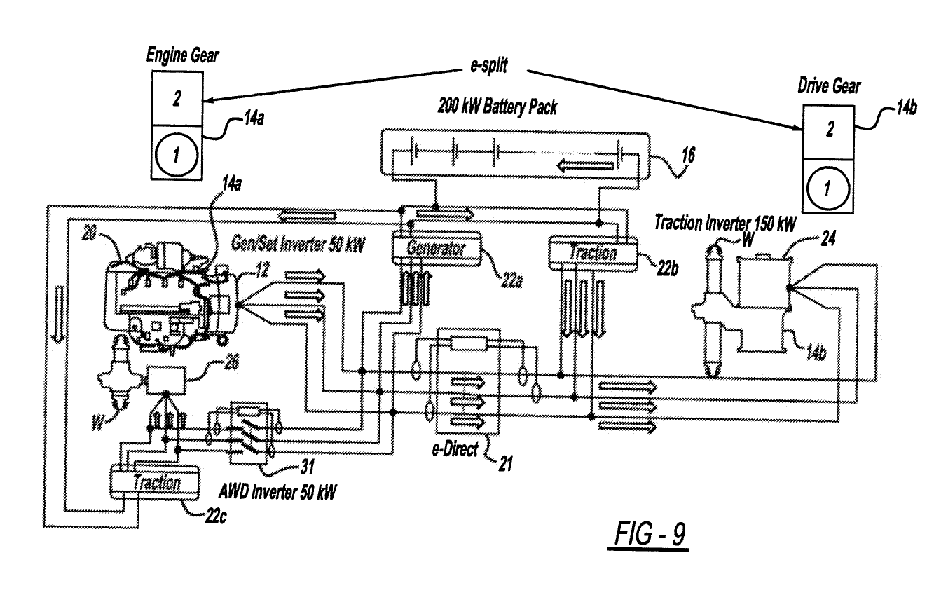

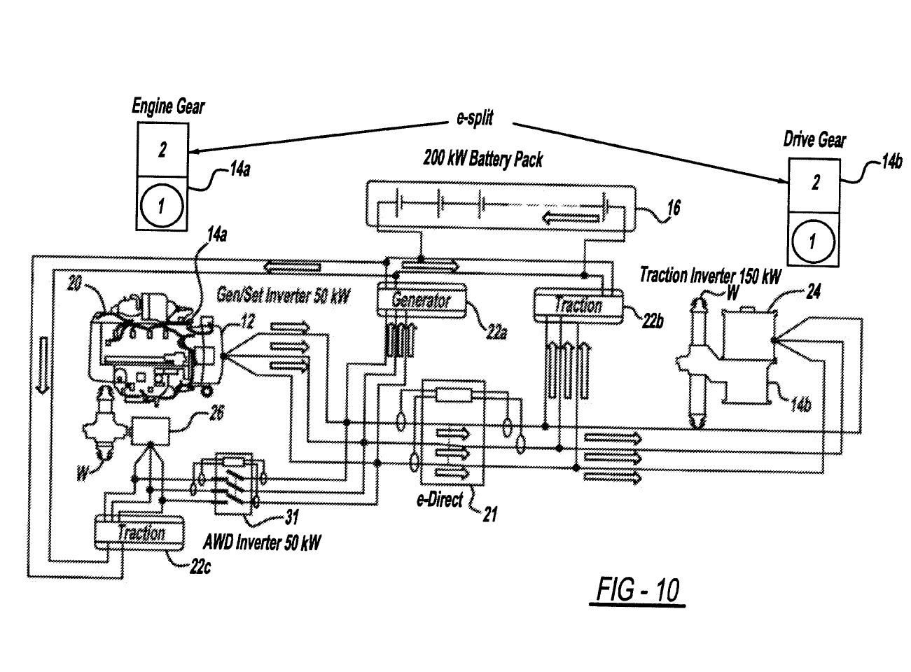

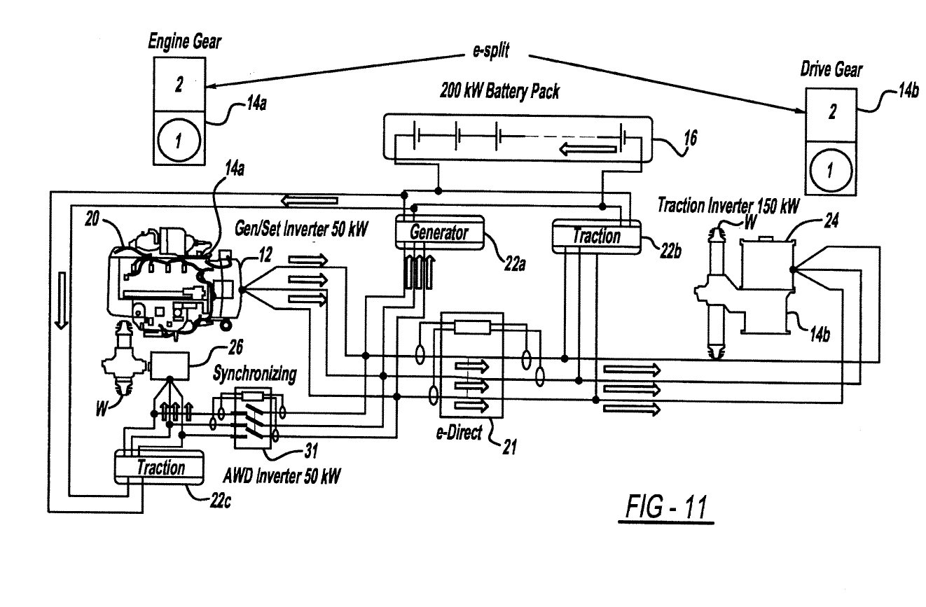

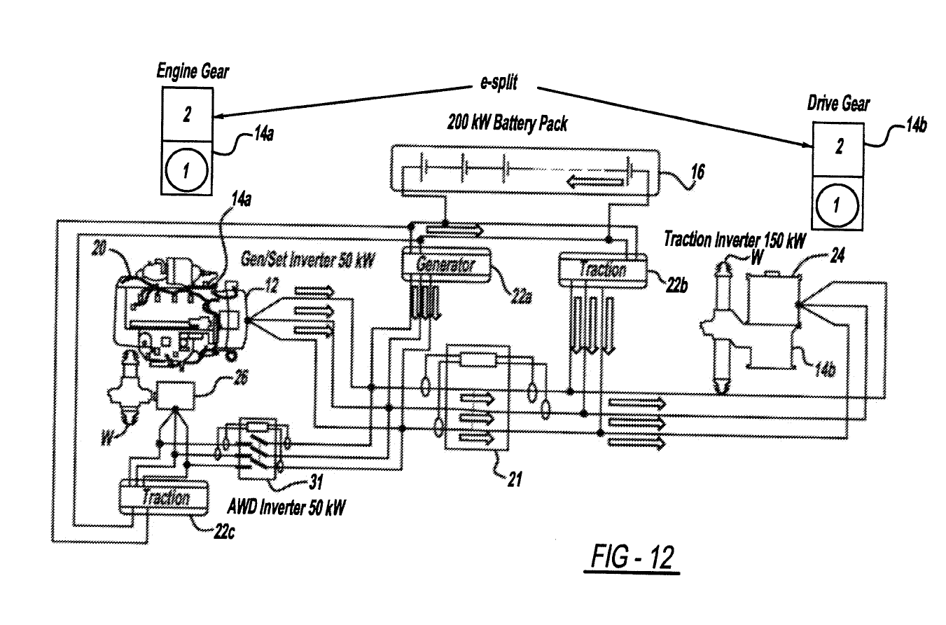

Vehicle 10 also includes a drivetrain 11 that operatively controls movement of the vehicle. A motor 24, that mechanically drives an axle of the vehicle that moves wheels of the vehicle, is powered by the power sources (i.e., a battery, engine, and/or generator). In the example of FIG. 1, vehicle 10 is a rear wheel drive vehicle with the rear wheels mechanically driven by motors 24. Motors 24 and generator 12 can be referred to as an electrical or electric machine. In an example, the terms “motor” and “generator” are directed to the flow of energy since each can be operated in reverse to accomplish the opposite function. Therefore, an electric machine can either generate power by operating with a negative shaft torque (i.e., a generator) or distribute power by producing positive shaft torque (i.e., a motor). In FIG. 2a-12, the electric machine is referred to as a motor/generator (“MG”). Accordingly, the vehicle can include an MG1 12 coupled to the engine 20 and an MG2 24 coupled to wheels W.

The architecture of the drive train is selectively determined, such as a series, parallel or parallel-split arrangement of the drive train components. In this example the drive train includes a MG1 12 and an MG2 24. Various types of MG's are available, such as an electric motor, or generator, permanent magnet synchronous machine, induction machine, or the like. The MG1 12 can include a housing, a stator disposed in the housing that is stationary, and a rotor that rotates about a central shaft that includes a permanent magnet. The MG1 12 converts mechanical energy received from engine 20 to electrical energy used to provide power to the wheels W, charge the on-board battery 16, or power auxiliary vehicle components. Typically, the output of MG1 12 is NC power that is converted to D/C power in an inverter 22A. The D/C power can then either be delivered to the battery 16 or another inverter 22B to convert back to NC power before powering any drive motors. Typical of such MGs and inverters, each has a predetermined operating efficiency corresponding to a given speed/torque band.

In this example, the drivetrain 11 also includes a gasoline powered engine 20 that provides supplemental power when required under certain operating conditions. Engine 20 is operatively coupled to MG1 12, such as via an engine output shaft. Accordingly, when the engine 20 runs, the MG1 12 typically runs as a result of their engagement to each other. The engine 20 can also have a predetermined operating efficiency at a corresponding speed/torque band. However, the ratio of engine speed efficiency with respect to generator speed efficiency may not be optimal within a particular speed/torque band.

Typical of electric machines, each has a predetermined operating efficiency corresponding to a given speed/torque band. However, the ratio of engine speed efficiency with respect to generator speed efficiency may not be optimal within a particular speedband. Thus, an e-Split transmission arrangement may be utilized, such that unique downsizing of the engine is feasible, with a corresponding reduction in power requirements (i.e. 150 kW to 125 kW 120 kW).

In an example of an e-Split arrangement, the drivetrain 11 includes a transmission 14A disposed between MG1 12 and engine 20. In an example, transmission 14A provides a mechanical linkage between the engine 20 and MG1 12 in line with the engine output shaft. The transmission 14A may be of any type, such as electronic, mechanical or electro-mechanical, and can be a multi-speed or continuously variable transmission, or the like to offer selectable effective gear ratios. The transmission varies the gear ratios, to facilitate the transfer of engine power to the generator. For example, it may be desired to run engine 20 at 3000 rpm and MG1 12 at 4500 rpm. Transmission 14A positioned between engine 20 and MG1 12 can allow each of the engine 20 and MG1 12 to independently operate at a desired speed and/or torque for a corresponding speed band. Engine 20 and MG1 12 can each define different torque/speed efficiency profiles. Allowing each to operate at different speeds can allow optimization by adjusting transmission ratio selection to operate each component as close to its corresponding speed identifiable from a measured efficiency map.

Various types of transmissions 14A may be utilized, such as a multi-speed transmission or continuously variable transmission, or the like. The transmission 14A may incorporate multiple gear sets between the engine 20 or MG1 12. Similarly, transmission 14A may utilize planetary gears. An arrangement of transmission 14A between engine 20 and MG1 12 may be incorporated with many different hybrid powertrain architectures. Transmission 14A allows for more efficient system operation as compared to a standard powertrain without a transmission. As a result of the enhanced efficiency, excess power may result and be supplied to an external component while the vehicle is parked. In an example, the vehicle can store excess power and distribute that power to an external source such as a grid or an external energy storage device.

The MG1 12 operating speed may be independent of the engine 20 operating speed. As a result, the use of a transmission 14A therebetween to control the transfer of power through different transmission ratios, the efficiency of the system can be enhanced. Operating efficiency profiles provide an engine designer with increased freedom in selecting the various engine operating points corresponding with predetermined vehicle operating conditions. Thus, an electric machine having lower torque characteristics can be selected, since the constant power operating region of the electric machine can still be utilized thereby still exhibiting the same performance. Variable speeds between the engine and generator can align the maximum efficiency of the generator with the current operating point of the engine.

In another example, the system can also include a second transmission 14B operatively positioned adjacent an inverter 22B located at the rear drive shaft coupled to MG2 24. The addition of another transmission 14B provides for the selection of drive gears depending on the operation mode of the vehicle, in a manner to be described. In this example, the inverter 22B has a power capacity of 150 kW.

Various types of transmissions may be utilized for either the first or second transmission, such as a multi-speed transmission or continuously variable transmission, or the like. The transmission may incorporate multiple gear sets between the engine and/or electric machine. Similarly, the transmission may utilize planetary gears. The arrangement of a transmission between the engine and electric machine may be incorporated with many different hybrid powertrain architectures. As a result of the enhanced efficiency of the transmission placement, excess power may be supplied to an external component while the vehicle is parked.

Referring to the FIGS. 2a-12, exemplary systems and methods of direct electrical connection (e-Direct), and potential combinations with a transmission split (e-Split) for multi-motor hybrid drive systems are illustrated. The vehicle 10 includes a power train that controls the operation of the vehicle. In these examples, the power train is a plug-in hybrid, and includes at least two electrical machines.

The system includes an energy storage device 16, such as the battery 16 that is in communication with the components that adds or subtracts power within the vehicle system. Various types of batteries are available, such as lead acid, or lithium-ion or the like.

A first inverter 22A is operatively in communication with a second inverter 22B, and the second inverter 22B converts DC electrical power back to AC electrical power. The second inverter 22B is operatively in communication with a second electrical machine MG2 24. MG2 24 converts the AC electrical power into mechanical energy that is available for use in the operation of the vehicle. In this example, the mechanical energy is transmitted to a drive shaft in order to control operation of the vehicle wheels W, i.e. front wheels or rear wheels.

It should be appreciated that the energy conversion process is less than 100% efficient, resulting in losses throughout the system. In an example, loss across an inverter can range from about 3% to 10%. The first electrical machine (MG1 12) is directly in electrical communication with the second electrical machine (MG2 24), so that AC power from the first electrical machine directly provides power to the second electrical machine. It should be appreciated that the first electrical machine may be operated at a speed and load wherein the power may be directly transferred to the second electrical machine. Various different examples and illustrations of the present disclosure are described in FIGS. 2a-12.

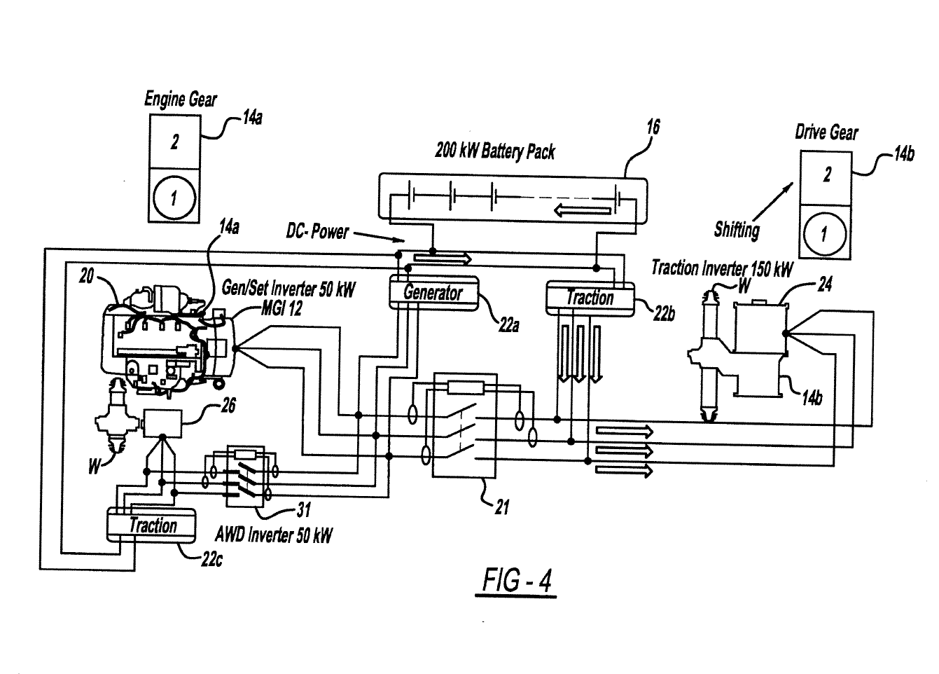

FIG. 2a illustrates an example schematic system for a vehicle 10 including a switch box 21 that allows for direct AC/AC connection between MG1 12 and MG2 24. Loss across a switch box 21 is relatively low and far less than an inverter. In this example, engine 20 is coupled to MG1 12 which can deliver electrical power to an inverter 22A to be received by a battery 16, another inverter 22B or a switch box 21. The energy can then be transferred to MG2 24 and then the wheels W. Energy then can flow in either direction as shown by the other FIGS. An exploded view of various operating states of box 21 is further shown in FIG. 2a. In this example, the switch box 21 can operate in three operating states represented by state 1 (21A), state 2 (21B), and state 3 (21C). Various potential modes of energy flow exemplary switch box modes are shown in FIGS. 4-12. Table 1 below illustrates various characteristics associated with each operating state.

TABLE 1

| Mode | Engine | Battery | Inverter1 | MG1 | Switch | Inverter 2 | MG2 | Description |
|---|---|---|---|---|---|---|---|---|
| Mode 1 | Off | Power Out | | | State 1 | DC to AC | AC to | EV-drive |
| | | | | | | | mechanical | |
| Mode 2 | Crank | Power Out | DC to AC | AC to | State 1 | DC to AC | AC to | Engine crank |
| | | | | mechanical | | | mechanical | while driving |
| Mode 3 | Power | Power | AC to DC | Mechanical | State 1 | DC to AC | AC to | HEV-Engine to |
| | | in/out | | to AC | | | mechanical | wheels, battery |
| | | | | | | | | boost or charge |
| | | | | | | | | as necessary |
| Mode 4a | Power | | | Mechanical | State 2 | | AC to | HEV-Engine to |
| | | | | to AC | | | mechanical | wheels |
| Mode 4b | Power | Power out | DC to AC | Mechanical | State 2 | DC to AC | AC to | HEV-Engine to |
| | | | | to AC | | | mechanical | wheels w/battery |
| | | | | | | | | boost using one |
| | | | | | | | | or both inverters |
| Mode 4c | Power | Power in | AC to DC | Mechanincal | State 2 | AC to DC | AC to | HEV-Engine to |
| | | | | to AC | | | mechanical | wheels w/battery |
| | | | | | | | | charge using one |
| | | | | | | | | or both inverters |
| Mode 4d | Power | Power | AC to DC | Mechanical | State 2 | DC to AC | AC to | HEV-Engine to |
| | | in/out/non | | to AC | | | mechanical | wheels using AC |
| | | | | | | | | and DC power, |
| | | | | | | | | battery |
| | | | | | | | | charge/boost as |
| | | | | | | | | needed |
| Mode 5 | Spinning | Power in | AC to DC | AC to | State 2 | AC to DC | Mechanical | Braking - Wheel |
| | (possible) | | | mechanical | | | to AC | power to battery |
| | | | | | | | | using one or both |
| | | | | | | | | inverters. Engine |
| | | | | | | | | may spin if extra |
| | | | | | | | | power is |
| | | | | | | | | available |
| Mode 6a | Power | | | Mechanical | State 3 | | AC to | HEV-Engine to |
| | | | | to AC | | | mechanical | wheels (reverse), |
| | | | | | | | | drive motor |
| | | | | | | | | spinning |
| | | | | | | | | backwards |
| Mode 6b | Power | Power out | DC to AC | Mechanical | State 3 | DC to AC | AC to | HEV-Engine to |
| | | | | to AC | | | mechanical | wheels (reverse), |
| | | | | | | | | drive motor |
| | | | | | | | | spinning |
| | | | | | | | | backwards |
| | | | | | | | | w/battery boost |
| | | | | | | | | using one or both |
| | | | | | | | | inverters |
| Mode 6c | Power | Power in | AC to DC | Mechanical | State 3 | AC to DC | AC to | HEV-Engine to |
| | | | | to AC | | | mechanical | wheels (reverse), |
| | | | | | | | | drive motor |
| | | | | | | | | spinning |
| | | | | | | | | backwards |
| | | | | | | | | w/battery charge |
| | | | | | | | | using one or both |
| | | | | | | | | inverters |
| Mode 6d | Power | Power | AC to DC | Mechanical | State 3 | DC to AC | AC to | HEV-Engine to |
| | | in/out/non | | to AC | | | mechanical | wheels (reverse), |
| | | | | | | | | using AC and |
| | | | | | | | | DC power, |
| | | | | | | | | battery |
| | | | | | | | | charge/boost as |
| | | | | | | | | needed |

Power is transferred across a 3-phase AC bus. Switch box 21 includes three lines/switches 25 for the three-phase AC transfer. State 1 is represented by box 21A where all three switches 25 are open. When the switches 25 are open, energy cannot transfer directly between MG1 and MG2. Accordingly, the energy is converted from AC (leaving MG1) to DC through inverter 22A and then is either received by battery 16 for charging or reconverted back to AC in the second inverter 22B before being delivered to MG2. Having two inverters allows for operation of either MG's without direct influence on the other. MG1 12 can run idle or be completely turned off while battery 16 delivers energy to MG2 24 through the second inverter 22B. Energy can be transferred from battery 16 to both MG1 12 and MG2 24. This can be desirable for cranking the engine and thus needing MG1 12 to operate as a motor rather than a generator to deliver energy to the engine 20. In an example, power can flow from MG1 12 to charge battery 16 and drive MG2 24 simultaneously.

As shown in box 21B, state 2 is an operating state where the three switches 25 are closed providing a direct electronic link between MG1 12 and MG2 24. Switch box 21B allows AC power generated in MG1 12 to flow directly to MG2 24. In this example, the energy flow bypasses the inverters and therefore removing undesired efficiency loss associated with the inverters 22. In this embodiment, MG1 12 is directly linked to MG2 and thus are operating at proportional speeds. This is ideal for cruise control conditions for example and increases efficiency of the power distribution of the vehicle. Energy loss across the switches associated with 21A is far less than that of inverters 22. Energy can flow directly through switch box 21A as well as through the inverters 22 and to battery 16 or the other inverter. Energy can be delivered in both directions (i.e., in and out of the battery 16 from and to MG1 12 and MG2 24). Accordingly, the wheels W can be powered by A/C power from the engine 20 and DC power from the batter 16. The battery can also be charging simultaneously while direct power is transferred from MG1 to MG2. The battery 16 can boost or charge using one or both inverters 22.

A third state (state 3) energy flow path associated with an operating state of switch box 21C. In this embodiment switches 27 (shown open in box 21A and 21B) are closed along with one switch 25. Switches 27, when closed, allow for a cross energy linkage across the three phases which allows direct energy flow between MG1 12 and MG2 24 while either MG1 or MG2 is operating in reverse. Accordingly, MG1 12 can spin forward while MG2 can spin backward.

In another example, FIG. 2b illustrates a box diagram of the system of FIG. 2a with a transmission 14A disposed between engine 20 and MG1 12 and a second transmission 14B disposed between MG2 and a wheel axle associated with wheels W. Referring to FIGS. 4-12, two transmissions 14A and 14B are provided, each being a two-speed transmission and thus effectively making the vehicle a 4-speed transmission system. It should be appreciated that the gear split arrangement selected is for exemplary purposes and other multiple or single transmission gear arrangements have been considered and within the scope of the present disclosure. Further in this example, there is an electrical split between the physically separated gear sets. Advantageously, the vehicle only utilizes the number of gears required to meet a particular speed/load requirement. The system can change gearing to operate at another speed/load band to match gearing to the requirement. Energy requirement are reduced by the number of gears selected for a particular operating mode.

In an example of an e-Split arrangement, gears are positioned between the engine 20 and MG1 12 and the wheel axle of wheels W and MG2 24. Note that 2 engine gears and 2 motor gears effectively provide 4 speeds with engine running. The inclusion of 2 or 3 gears at the engine provides for compact packaging, such as via a single simple planetary (2 gears at the engine) or a single compound planetary (3 gears at engine) arrangement. The system may further include one or more clutches, such as two clutch arrangement to implement either 3 or 2 engine gears. Typically, the transmission can include a clutch impact by decoupling. It should be appreciated that the use of 3 gears at the engine and 2 gears at the motor effectively translates into 6 gears.

The drivetrain may include other components that are known in the art. For example, a clutch, such as a wet or dry clutch, may be located on the shaft to switch between different speed ratios. Additional powertrain components may be included and are conventionally associated with the operation of the vehicle.

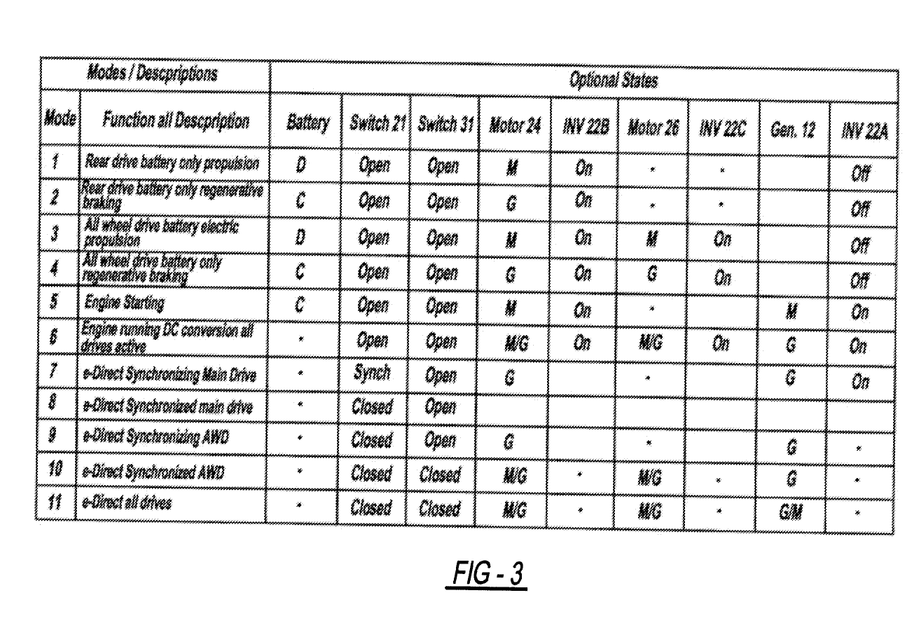

FIGS. 4-12 illustrate various exemplary embodiments associated with the present disclosure. The example systems include a third electrical machine MG3 26 coupled to front wheels W. These embodiments allow for selective four-wheel drive modes for example vehicles associated with the present disclosure. MG3 26 is can be linked directly to the switch box 21. Power can be delivered directly from engine 20 to MG3 26. In these embodiments, a second switch box 31 is provided along with a third inverter 22C, both coupled to MG3 26. Accordingly, the presence of a third inverter and a second switch box allows for various energy flow patterns between the engine, battery, inverters, and motors/generators. FIG. 3 is a chart illustrating functional descriptions for different modes associated with the multiple switch box, inverter, and motor/generator embodiments. Modes 1-11 are exemplary states of operation associated with the operating status of the switch boxes, battery, inverters, and motors/generators. Mode 7 shows an example where a synchronization happens which makes sure the switches can close so the phases are in line. In the battery column, “D” stands for discharging and “C” stands for charging.

Operating the vehicle in e-Direct (i.e., the switches 25 and/or 27 are closed) significantly reduces load on the inverters of the vehicle 10. Accordingly, inverter size can be reduced relative to standard inverters used in vehicles without a switch box 21 and/or 31. Reducing inverter size can reduce hardware costs of the vehicle and overall system efficiency.

The addition of a compliant mechanical coupling device (such as a clutch) can increase the versatility of the system, such as the use of e-Direct to direct power distribution between front axle and rear axle of the vehicle 10. The e-Direct hardware can be positioned such that either the front MG1 12 or rear motor/generator MG2 24 can be engaged. This can also be implemented wherein both drive motors 24 and 26 are engaged at the same time or independently.

The transmissions of the vehicle can operate as a mechanical coupling device. An example of a mechanical coupling device may be a clutch, such as in a conventional manual transmission or a dual clutch transmission, a wet clutch as found in an automatic transmission, a torque converter as found in an automatic transmission, a dog clutch, or any other mechanical linking device that allows ˜100% torque transfer in one operating mode and ˜0% torque transfer in another operation mode. The mechanical coupling device may also be able to transfer a wide range of torque from 0-100% or have torque multiplying capacity, such as in an automatic transmission torque converter. As a result, a generator 12 may be disengaged from the engine 20 and power or torque may be transferred to the generator MG1 12 while the engine 20 is spinning at a speed independent of the generator. A feature such as e-Direct can be enhanced by allowing e-Direct to be engaged when the vehicle is stopped through the use of the mechanical slip device (i.e., coupling device or the transmission). The generator 12 can be hard coupled to the motor 24 through the 3-phase bus, making the generator/motor 12/24 act as if they are mechanically linked. Another advantage is that the transmissions 14A/14B allow the vehicle 10 to be started without the need for either inverter 22 or battery 16.

The inclusion of a switch box 21 with switches 25, such as a two-position switch, allows e-Direct operation to either the front or rear wheels W. The pole/gear ratio can be optimized so that the engine 20 can transfer power through e-Direct in multiple gears, i.e. at multiple optimized engine speeds. In an example, the system may include hard coupling the 3-phase AC power cables to the same bus as the generator MG1 12 or the rear drive motor MG2 24. A front drive motor MG3 26 can have the same electrical frequency as the rear motor MG2 24. This means that the two motors will always spin at speeds inversely proportionally to their relative number of pole. However, the axle speed can vary as the vehicle drives around turns, tire wear, gearing, etc. and therefore the compliant mechanical coupling accommodates for these variations. As the vehicle goes around a turn, the front wheels W travel a further distance than the rear wheels W. This means that the front motor MG3 26 spins proportionally faster than the rear motor MG2 24. Since the e-Direct configuration hard couples the electrical phases, the front motor MG3 26 can benefit from a compliant coupling between the motor and wheels W. The compliant coupling (with similar possibilities as described by the engine/generator compliant coupler) and drive unit between the front motor MG3 26 and wheels W can be configured so that the motor always spins faster than the coupling output speed (using the transmission). This means that the motor may provide power to the wheels.

In another example the front wheel drive motor MG3 26 may be hard coupled to the generator MG1 12. Thus, the front drive motor MG3 26 and generator MG1 12 may spin at a constant proportional speed. The inverter 22A can either power the front wheels W, absorb power from the generator MG1 12, or modulate power as the generator MG1 12 powers the front wheels W during e-Direct operation. A second e-Direct switching device 31 may be added so that the front and/or rear motor is proportionally hard-coupled coupled to the generator MG1 12. As a result, the first inverter 22A may power the front motor MG3 26 or electric machine. The generator MG1 12 will spin the front motor MG1 26 so that the engine 20 can be decoupled if so required.

In e-split operation, numerous variations can be made using the above described configuration as its basis. For example:
Switching inverters on/off to either operate conventionally or through inverter-less operation.
Using IGBTs or other controlled circuitry to switch between routing electrical machine power to the inverter or to other electrical machine.
Using different types of motors such as permanent magnet synchronous machines or AC induction machines in order to increase or reduce the tolerance for timing variations between the two electrical machines.
Rectifying or otherwise modifying the magnitude or timing of the AC signal to control output power.
Adjusting phase or bus capacitance, inductance or any other characteristic in order to manage the power or robustness between the two electrical machines.
Actively or passively controlling engine power to align timing between the electrical phases of each electric machine.

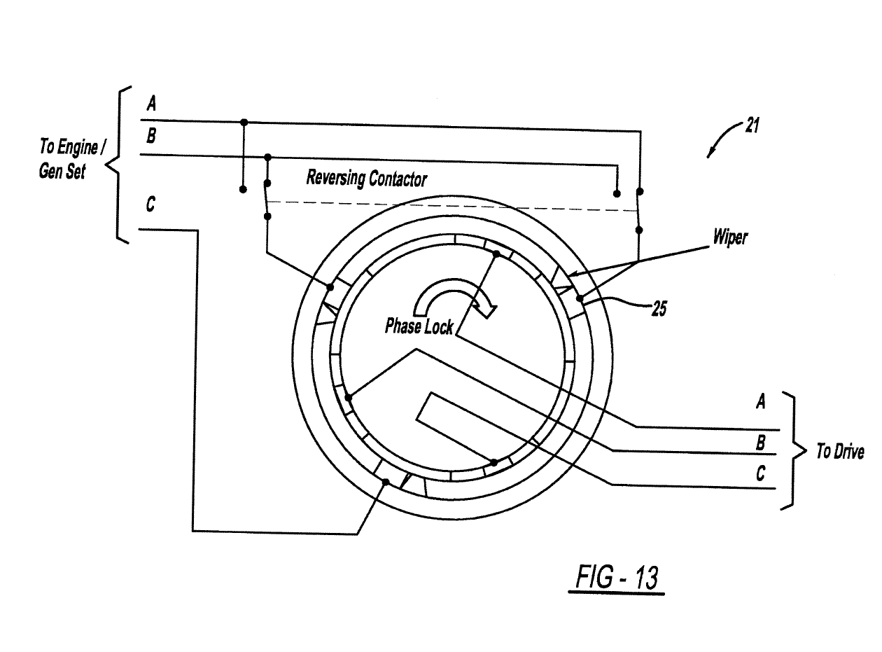

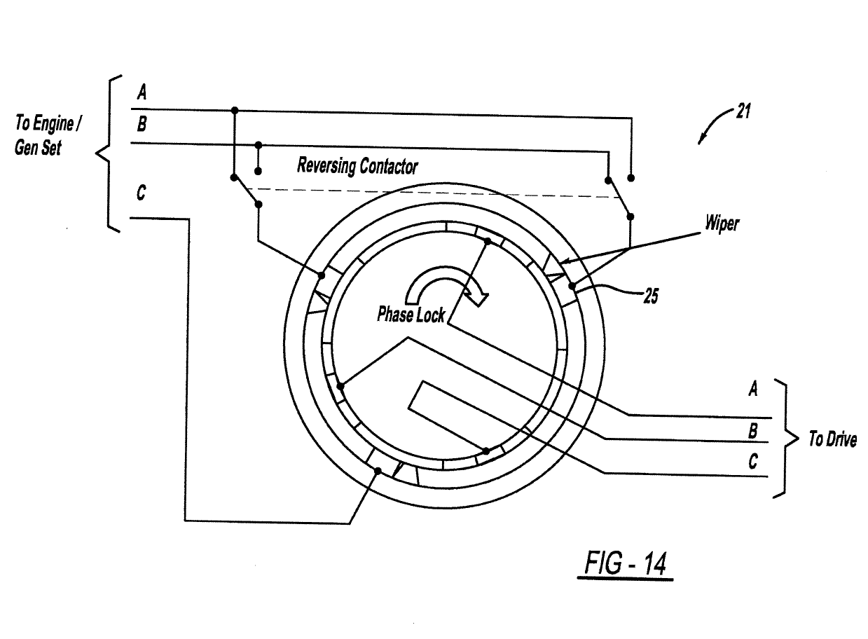

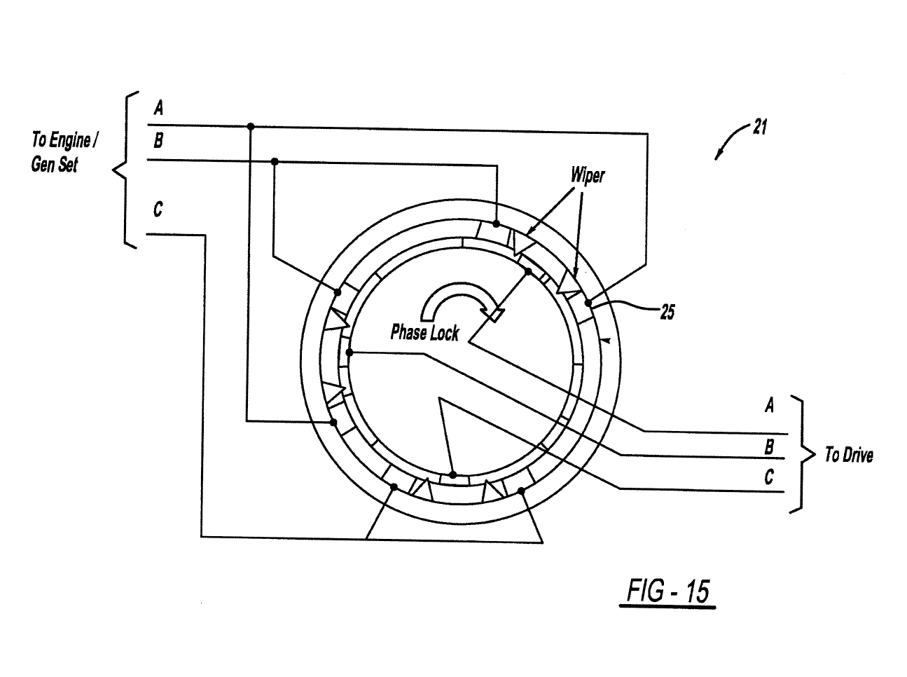

Referring to FIGS. 13-15, an example of an electrical energy power management system is illustrated that includes an e-Direct switch box 21 or 31 that controls the distribution of power between the engine 20 and a drive motor MG2 24 or MG3 26, depending on the operating mode of the vehicle. The switch box 21 can be located between the engine 20 and MG1 21, and eliminates AC/DC power conversion losses throughout the system due to the direct connection thereof. It should be appreciated that the energy conversion process is less than 100% efficient, resulting in losses throughout the system. As shown in the FIGS., the first electrical machine MG1 12 is directly in electrical communication with the second electrical machine MG2 24 via the switch box 21, so that AC energy from the first electrical machine MG1 12 directly provides power to the second electrical machine MG2 24. It should be appreciated that MG1 12 may be operated at a speed and load wherein the power may be directly transferred to the second electrical machine.

Various types of switches are contemplated, such as the rotational switch of this example. Switch 21 reduces losses associated with power conversion between AC-DC or electrical to mechanical sources.

In an example, switch box 21 includes a contacting mechanism and a sensing and control element. Switch box 21 can be a 3-phase AC switch although other embodiments are considered. One side of the contacting mechanism is connected to the 3-phase output from the generator while the other side is connected to the 3-phase input to the traction motor. In addition, there are means to allow for phase reversal by swapping two of the phases. In a further example, a rotary (where the contacting mechanism is actuated by means of a rotary actuator) or linear (where the contacting mechanism is actuated by a linear actuator or a relay or the like) switch is provided. The sensing mechanism senses the voltage, frequency and phase relationship between the voltage at either side of the switch box 21. Based on this input and using a suitable control algorithm depending in the state of the drive, the switch box 21 can be actuated to engage the e-Direct mode (i.e., close the switches 25). The switch box 21 can be in communication with a vehicle/hybrid controller to coordinate the switch operation. This communication can be effected via CAN protocol or the like.

In an example rotary switch box 21 as shown in FIGS. 13-15, includes two parts—a stationary one that connects to the generator output and a part that can rotate relative to the stationary one that connects to the motor input. The rotary part can include copper (or other conducting material) bars to which the connections are made. The connections from the stationary part to the rotary part are made through brushes (metallic, graphitic or combination) that are able to slide on the surface of the rotary part. There may also be a wiper integrated or co-located with the brushes to help clean any conductive debris. The rotary part may be connected to a rotary actuator such as a stepper motor or the like. Once the sensing circuit and controller determine that the conditions to engage the switches 25 are satisfied, the rotary actuator is energized to actuate the rotary part and connect the motor input to the generator output. The linear example can be similarly be implemented by replacing the rotary elements above with linear ones.

In a further example, switch box 21 is an electro-mechanical switch where the mechanical contactor are actuated using a relay mechanism or the like. A variation of the electro-mechanical switch is a hybrid electronic and electro-mechanical switch. In this example, there is a power electronic device (IGBT, MOSFET or the like) in parallel with each connector of the electromechanical switch. Upon receiving the command from the controller, the power electronic device is closed first then the electromechanical switch is activated. The power electronic device closure is much faster than the electro-mechanical switch and so permits effective closing sooner. The electro-mechanical switch can handle the operating currents and so the power electronic device needs to only handle peak current for a short duration.

In an example where close to identical speed alignment between MG1 12 and MG2 24 is not possible, then the switches in box 21 need to close relatively quickly. Mechanical contactors can be used since they have a high level of efficiency, however, their response time may not be adequate in some situations. A hybrid power-electronic/mechanical contactor as shown in box 21 can be used. In an example, two IGBTs for each mechanical contactor are included that allow current to flow in either direction, however only one IGBT may be necessary. This can be used with other power electronics devices, including but not limited to, MOSFETS, thyristors, SCRs, etc. When the switches are closed allowing direct power transfer between electric machines, voltage levels can be monitored by a controller. When the 3-phase voltage aligns (even if just for a brief moment) the solid state switching device engages locking the phases together. This keeps the voltage over the mechanical contactors near zero, which allows them to close with little risk.

In operation, various potential operating modes are described, by way of example, and others are contemplated. For example, braking of the vehicle closes or shuts off the e-direct feature by opening the circuit. In another example, during acceleration the e-direct switch is closed below a predetermined speed, such as 5-15 mph, and above which the switch is further closed to fully implement the e-direct feature. In another example, during transitional modes, such as power demand modes, e-direct is implemented. It should be appreciated that the use of e-direct and e-split may be implemented together or independently.

The system can sense a generator/motor speed using a sensor, and engine speed using a sensor. Each of the speed signals are sent to a processor. Logic within the processor evaluates both speed signals and transmits a signal to the transmission to selectively control the transmission gears to further control the transfer of engine power to the generator/motor. As a result, the generator/motor can operate at a speed that is independent of the engine speed in order to maximize the efficiency of the system. As a result of these efficiencies, a vehicle designer has increased freedom in the selection of the engine operating points for maximizing system efficiency. Further, a signal is sent to the e-direct switch to control power distribution.

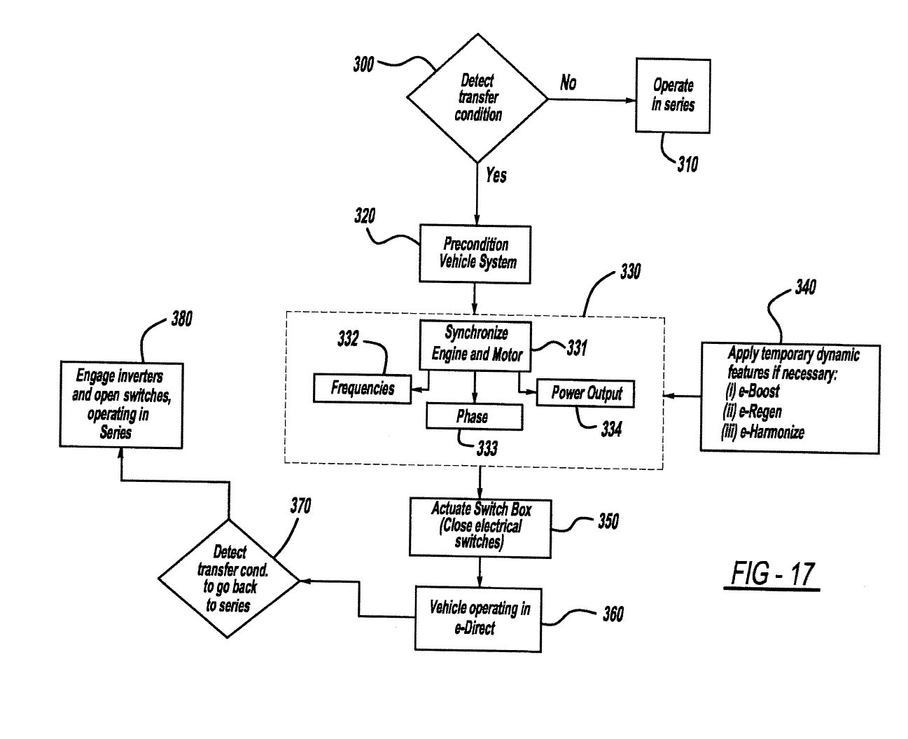

A method of switching and controlling a transition between a series driving mode (which can be a conventional operational state of driving) and an e-Direct mode is provided. The methodology may be implemented using any one of the previously described systems. Further, the methodology may be utilized in a vehicle having both an e-Split mode and e-Direct mode. Referring to FIG. 17, the method of transitioning between the two different modes is provided. Each step can include one or more sub-steps to carry-out the process. Controlling between series driving (i.e., when the inverters are used to transfer energy between the generator and the motor), and e-Direct and/or e-Split manages driver demand regarding drivability, system efficiency, and seamless mode transitions.

The drivability can be optimized or improved by considering vehicle agility and fuel efficiency. The system efficiency can be increased by calculating a desirable mode including some or all component losses for a given driver demand. The gears will be utilized to operate the motor and/or the generator within a desired or suitable speed range.

The methodology begins in block 300 with the step of detecting a transfer condition. Detection of the transfer condition may be performed in a vehicle system controller by measuring certain parameters and correlating the measured parameters to a predetermined efficiency comparison for operating the vehicle. An example of a transfer condition is a vehicle drive condition such as a cruise mode, a steady state mode or the like. The vehicle controller can estimate between a series mode and e-Direct mode and estimate efficiency conditions. Efficiency charts can provide decision criteria for determining if e-Direct is more efficient. Typically, the generator and the motor must be operating under equal electrical frequencies. For a given vehicle speed, the engine and generator will be operating at a certain RPM or speed to be within an efficiency range and the motor will have its own efficiency profile. The system controller must evaluate if operating in e-Direct is more efficient than operating in series where losses across inverters occurs. Since the transfer condition was met, which controls transition from a series to e-Direct, the M_{demand}<M_{genmax} (maximum generator power output for a given condition or target state condition), and overall system losses have been considered for a desired operating condition.

To transition into e-Direct, the process should achieve a substantially seamless transfer of the driver demand to the driveline output. The e-Direct switch can then be closed. This step includes instantaneously switching off the G-INV. Then the M-INV is controlled to idle such that it no longer is producing power output. The e-Harmonize function will allow the M-INV to monitor the transition phase regarding driveline jerks to counteract.

If determined that the condition is not met in block 310, then the system will advance to block 310. In block 310, the vehicle continues to operate, such as in a series mode. The system controller can programmed with an algorithm to monitor continuous driver demand, system status, and losses to generate a transfer condition.

If determined that the transfer condition is met in block 300, then the methodology advances to block 320 and continues. For example if the vehicle is operating under certain conditions where e-Direct mode would place the system in a more efficient operating condition by avoiding electrical losses over the inverters as previously described, then the transfer condition has been met and the decision to operate in e-Direct will generate a signal to begin preconditioning of the system in box 320.

An example of preconditioning the system is illustrated in block 330 and includes synchronizing motor and generator as shown at block 331. The synchronizing the motor and generator may include synchronizing: (i) electrical frequencies—as shown at block 332; (ii) electrical phases as shown at block 333; and (iii) power output as shown at block 334. The electrical frequencies should be equal or operating in a range where they will momentarily overlap so the system can accommodate for any periodic difference. Note that the electrical frequencies should be equal, not necessarily the speed of each component. The speeds can be proportional so long as the electrical frequencies are equal. The phases should be aligned. The power output, which can be torque in certain examples, should be equal.

Preconditioning includes that the engine/generator and motors have been synchronized on electrical frequency, phase (Phase lock loop), and power output. A phase-locked loop circuit responds to both the frequency and the phase of the input signals nGen (frequency of generator), pGen (phase of generator) and nMot (frequency of motor), pMot (phase of motor), automatically raising or lowering the frequency of a controlled oscillator (input for engine, generator speed control) until it is matched to the reference nMot, pMot in both frequency and phase. The load preconditioning is achieved to ensure that the generator produces the same power output as the motor, M_{gen}=Mₘₒₜ. Accordingly, M_{demand}=Mₘₒₜ=M_{gen} (inverter for motor and generator are still active).

In another example of preconditioning, certain criteria may be satisfied. The driver power output demand (M_{demand}) is within a predetermined operating range. Further, the engine should be on as opposed to being off and allowing the generator to spin. The motor should be producing a power demand substantially equal to driver demand: Mₘₒₜ=M_{demand}. The generator should be in a generating mode. The inverter for the generator (G-INV) and the motor (M-INV) should be active. The 3-phase contactors may be open. These preconditioning conditions occur prior to actuating the e-Direct switch. For preconditioning, the motor and generator are synchronized with two actors. The engine operates as an open loop speed controller. The generator acts parallel as a closed loop controller to eliminate a phase difference. The generator then experiences load preconditioning to produce equivalent power output as the motor. Accordingly, a condition for closing contactors is achieved.

In a further example of a preconditioning step, three dynamic temporary features as shown at block 340 may be provided to facilitate the preconditioning: (i) e-Boost; (ii) e-Regen; and (iii) e-Harmonize. E-Boost may be activated to temporarily increase driver demand if the dynamic response of the driver demand (e.g., tip-in, when driver is off the pedal and then pushes the pedal) would not be achieved. Accordingly, e-boost will pull power from the inverter to compensate. E-Regen is an opposite function and condition of e-Boost. This feature may be activated to temporarily decrease driver demand if the dynamic response of the driver demand (e.g., tip-out, when driver is on the pedal and then releases) would not be achieved. E-Harmonize may be activated to temporarily counteract on driveline output oscillation caused by shifting or in case of not fully synchronized mode transition. The controller looks to both state of the generator and the motor to add or remove current to smooth transition between modes.

Once the preconditioning of the vehicle system is complete, the methodology advances to block 350 and engages e-Direct, such as by actuating the e-Direct switch. Actuating the switch box 350 includes closing the electrical switches. The methodology advances to block 360, and the vehicle continues to operate in an e-Direct operating mode. Once the transfer condition and the preconditioning steps are satisfied, the 3-phase connectors of the e-Direct switch are closed. This may include simultaneously performing actions such as switching-off G-INV, closing contactors, or offloading M-INV (Mₘₒₜ=0 Nm). M-INV can still be active to counteract on possible jerks on the motor output. As the nGen and nMot are equal and in phase and M_{gen} is equal M_{demand} and Mₘₒₜ, the vehicle speed should maintain equal as before closing the contactors. M_{demand} will be directly transferred from the generator to the motor without the conversion losses of both inverters.

The methodology advances to block 370 to determine if a condition is met to disengage e-Direct. Block 370 determines whether a predetermined condition is met to transfer the system back to a series mode. An example of a condition is if M_{demand}>M_{genmax}. Another example of a condition is if a charge sustaining mode or vehicle speed is less than a predetermined minimum vehicle velocity under e-Direct conditions.

The methodology advances to block 380 and the transition occurs. For example, transfer of the driver demand to the driveline output may include the steps of switching on G-INV, controlling G-INV to idle (input=0 Nm). M-INV and G-INV are controlled. The motor takes over the driver demand from the generator and inverters are brought back into the loop. Load transfers from generator to monitor is finalized, such as by opening the e-Direct switch to move to the series mode. An e-Harmonize step can be used where the M-INV will monitor to transition phase regarding driveline jerks to counteract.

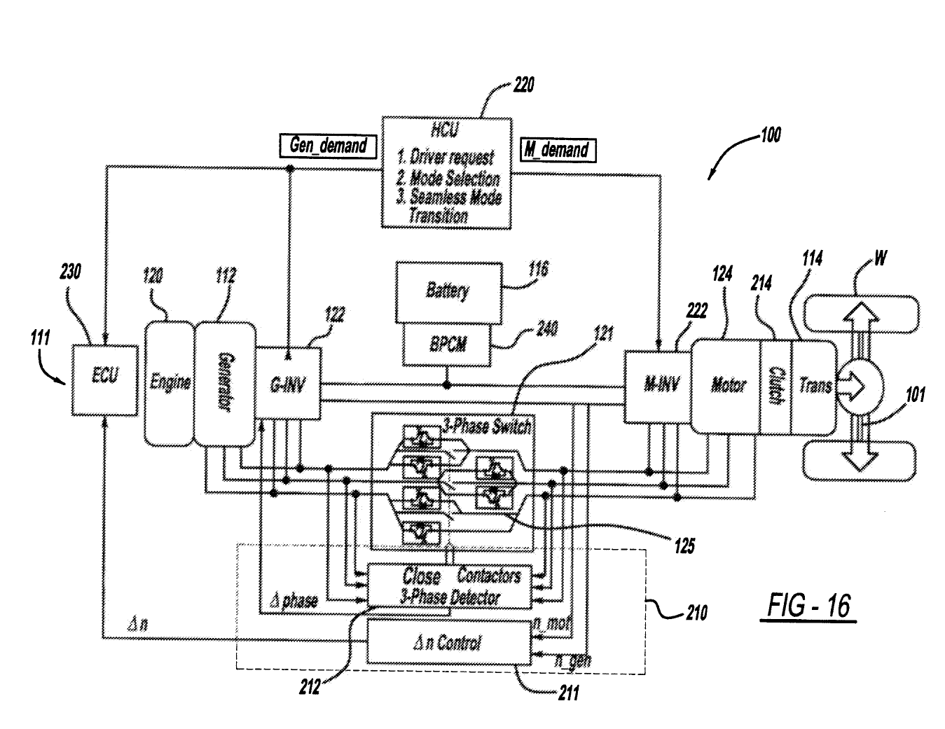

FIG. 16 illustrates a control schematic on an example vehicle operating system 100. System 100 includes a drivetrain 111 that operatively controls movement of the vehicle. A motor 124, that mechanically drives an axle 101 of the vehicle that moves wheels W of the vehicle, is powered by the power sources (i.e., a battery 116, engine 120, and/or generator 112). Motor 124 and generator 112 can be referred to as an electrical or electric machine. In an example, the terms “motor” and “generator” are directed to the flow of energy since each can be operated in reverse to accomplish the opposite function. Therefore, an electric machine can either generate power by operating with a negative shaft torque (i.e., a generator) or distribute power by producing positive shaft torque (i.e., a motor). Accordingly, the vehicle can include an generator 112 coupled to the engine 120 and a motor 124 coupled to wheels W. In FIG. 16, motor 124 is further coupled to a transmission 114 and a clutch 214. The generator 112 is coupled to an inverter 122 (G-INV) and the motor 124 is coupled to an inverter 222 (M-INV).

Typically, the output of generator 112 is A/C power that is converted to D/C power in an inverter 122. The D/C power can then either be delivered to the battery 116 or another inverter 222 to convert back to NC power before powering any drive motor 124. Typical of such motors/generators and inverters, each has a predetermined operating efficiency corresponding to a given speed/torque band. In this example, the drivetrain 111 also includes a gasoline powered engine 120 that provides supplemental power when required under certain operating conditions. Engine 120 is operatively coupled to generator 112, such as via an engine output shaft. Accordingly, when the engine 120 runs, the generator 112 typically runs as a result of their engagement to each other. The engine 120 can also have a predetermined operating efficiency at a corresponding speed/torque band. However, the ratio of engine speed efficiency with respect to generator speed efficiency may not be optimal within a particular speed/torque band. An electrical switch box 121 is disposed between the generator 112 and motor 124 and includes a plurality of electrical switches 125. In this example, switch box 121 includes 3-phase switches 125.

In the example of FIG. 16, a hybrid control unit (HCU) 220, also referred to as a vehicle control unit, is coupled to each inverter 122, 222 and monitors electrical parameters. It is further coupled to an engine control unit (ECU) 230 that controls engine behavior. Shown in dotted lines is pseudo-control box 210 that can be included in the ECU 230 or HCU 220. Box 210 is effectively coupled to the switch box 121 and the inverters 122 and 22 as well as the generator 112 and motor 124. Box 210 monitors change in frequency between the generator and motor represented by Δn and controls behavior associated with the preconditioning steps as represented by box 211. The An value is then monitored by either the ECU 230 or HCU 220. Box 212 is a 3-phase detector that monitors the phases of the generator 112 and the motor 124. Control box 210 provides the monitoring function to satisfy the steps of the method of controlling.

The hybrid vehicle may include other features conventionally known for a vehicle, such as a gasoline motor, other controllers, a drive train or the like. Many modifications and variations of the present disclosure are possible in light of the above teachings. Therefore, within the scope of the appended claim, the present disclosure may be practiced other than as specifically described.

What is claimed is:

1. A method of controlling transition of operational modes in a hybrid vehicle comprising the steps of:
(a) providing a vehicle operating system having a generator coupled to an inverter and a motor coupled to an inverter, and a switch box disposed between the generator and the motor, the switch box having a plurality of electrical switches that open and close to allow for direct electrical connection between the generator and the motor;
(b) detecting a transfer condition using the vehicle system controller to transition from a first operating mode to a second operating mode, wherein the transfer condition defines a predetermined efficiency threshold of the second operating mode being more efficient than the first operating mode;
(c) preconditioning the vehicle system including the steps of: (i) synchronizing electrical frequency output from the generator and motor to be either equal or within a range such that they overlap; (ii) synchronizing electrical phases of generator and motor to be aligned; (iii) synchronizing power output from the generator and power output from the motor to be proportional; and
(d) actuating the switch box to close the plurality of switches allowing the generator and motor to electrically couple and allow power output to transfer between the generator and the motor.

2. The method of claim 1, wherein the first operating mode defines operating the vehicle system as a series wherein the power output from the generator and the motor travels through each respective inverter and through a battery of the system.

3. The method of claim 1, wherein the second operating mode defines operating the vehicle system in a direct mode wherein the generator and the motor are electrically coupled allowing for power output to transfer directly therebetween through a switch box.

4. The method of claim 1, wherein the detection of a transfer condition includes monitoring efficiency profiles of the vehicle system under vehicle operating conditions and generating a signal to switch from the first operating condition to the second operating condition in a situation allowing for direct electrical connection between the generator and the motor defined in the second operating mode will operate the system more efficiently than in a series defined in the first operating mode.

5. The method of claim 4, wherein the transfer condition includes a detection of proportional electrical frequencies from the generator and the motor.

6. The method of claim 1, wherein the preconditioning of the vehicle system further includes a temporary dynamic feature of boosting power output as a response to a condition where motor power output temporarily does not meet generator power output.

7. The method of claim 6, wherein the boost is delivered from the inverter of the motor to increase power output of the motor to match power output of the generator.

8. The method of claim 1, wherein the preconditioning of the vehicle system further includes a temporary dynamic feature of regenerating power output as a response to a condition where motor output temporarily exceeds generator power output.

9. The method of claim 8, wherein the regenerating is delivered from the inverter of the generator to increase power output of the generator to match power output of the motor.

10. The method of claim 1, wherein the precondition of the vehicle system further includes a temporary dynamic feature of harmonizing electrical output from either the generator or the motor to deliver or remove current to ensure a smooth transition from the first operating mode to the second operating step.

11. The method of claim 1, wherein actuating the switch box closes the plurality of electrical switches and including the steps of: (i) switching off the inverter of the generator; (ii) closing contactors of the electrical switches; (iii) off-loading the inverter of the motor by allowing it to dissipate to zero power output.

12. The method of claim 1, further comprising the step of transitioning between the second operating mode to the first operating mode including: (i) switching on the inverter of the generator and operate at idle; (i) switching on the inverter of the motor; (iii) synchronize motor to maintain vehicle driver demand; and (iv) open electrical switches in the switch box.

13. The method of claim 12 further comprising a harmonizing temporary step to maintain phase and electrical current to prevent driveline jerks.

14. A system of controlling transition of operational modes in a hybrid vehicle comprising:
(a) a vehicle operating system having a generator coupled to an inverter and a motor coupled to an inverter;
(b) a switch box disposed between the generator and the motor, the switch box having a plurality of electrical switches that open and close to allow for direct electrical connection between the generator and the motor;
(c) a vehicle control coupled to the generator, motor, and switch box and operable to electrically monitoring vehicle performance and electrical parameters to detect a transfer condition to transition from a first operating mode to a second operating mode, wherein the transfer condition defines a predetermined efficiency threshold of the second operating mode being more efficient than the first operating mode; wherein the controller preconditions the vehicle system by: (i) synchronizing electrical frequency output from the generator and motor to be either equal or within a range such that they overlap; (ii) synchronizing electrical phases of generator and motor to be aligned; and (iii) synchronizing power output from the generator and power output from the motor to be proportional; and wherein the controller actuates the switch box to close the plurality of switches allowing the generator and motor to electrically couple and allow power output to transfer between the generator and the motor.
